(19) United States
(12) Patent Application Publication
(10) Pub. No.: US 2024/0335768 A1
(43) Pub. Date: Oct. 10, 2024

(54) DEFOAMING COMPOSITIONS WITH POLYDIMETHYLSILOXANES, ORGANOPOLYSILOXANE RESINS, ALKYL ETHERS AND WITHOUT 2,2,4-TRIMETHYL-1,3-DIISOBUTYRYLOXYPENTANE

(71) Applicant: Wacker Chemie AG, Munich (DE)

(72) Inventors: Christof Brehm, Munich (DE); Jürgen Kugler, Munich (DE); Andreas Meier, Munich (DE)

(73) Assignee: Wacker Chemie AG, Munich (DE)

(21) Appl. No.: 18/578,733

(22) PCT Filed: Jul. 16, 2021
(86) PCT No.: PCT/EP2021/069972

§ 371 Date: Jan. 12, 2024

(51) Int. Cl. B01D 19/04; C02F 1/20

(52) U.S. Cl. CPC B01D 19/0409; C02F 1/20; C02F 2305/04; C02F 2307/12

(57) ABSTRACT

Defoamer compositions along with methods of producing the same. Where the defoamer compositions are used to defoam an aqueous media. Where the defoamer compositions include (A) polydimethylsiloxanes of the general formula (I), (B) fillers, (C) organopolysiloxane resins formed from units of the formula (II), (D) optionally polyorganosiloxanes of the general formula (III), (E) optionally nonionic emulsifiers, (F) mono-, di- or trialkoxyalkyl ethers of the following formula (IV), (G) nonaqueous solvents other than component (F), (H) optionally an alkaline or acidic catalyst or reaction product thereof with components (A) to (F), and involvement of 2,2,4-trimethyl-1,3-diisobutyryloxypentane and polyethersiloxanes is ruled out.

The invention relates to a method of defoaming aqueous media, especially aqueous surfactant formulations comprising defoamer compositions based on polysiloxanes.

In many liquid, especially aqueous, systems that contain surface-active compounds as desirable or else undesirable constituents, foam formation can cause problems when these systems are brought into more or less intensive contact with gaseous substances, for example in the sparging of wastewaters, in the intensive stirring of liquids, in distillation, washing or dyeing processes, or in filling operations.

This foam can be controlled by mechanical means or by the use of defoamers. Siloxane-based defoamers have been found to be particularly useful here. Defoamers based on siloxanes are prepared, for example, according to DE-AS 15 19 987 by heating hydrophilic silica in polydimethylsiloxanes.

Defoamers based on polydimethylsiloxanes have the disadvantage that polydimethylsiloxanes have poor compatibility with most surfactant systems, for example wetting agents or liquid washing compositions, and have a tendency to separate out, which is very undesirable. There have therefore been many efforts to find defoamers that have good compatibility in liquid washing compositions and have good activity even after storage.

U.S. Pat. No. 4,477,371 A (DE 3 235 256) describes self-emulsifying defoamers containing organopolysiloxanes, fillers, surfactants and 2,2,4-trimethyl-1,3-diisobutyryloxypentane. They have good efficacy but limited compatibility.

WO 2019/057754 discloses the use of concentrates containing polysiloxanes, ester oils or mineral oils, nonionic surfactants and solvents, and optionally water and acids, in amounts of 0% to 5% by weight in fabric softeners.

The problem addressed was that of providing compositions that, in use as defoamer of aqueous media, especially aqueous surfactant formulations, have good compatibility with the aqueous media and good efficacy even after storage.

This problem is solved by the invention.

The invention provides a method of defoaming aqueous media, preferably aqueous surfactant formulations, with compositions comprising

(A) polydimethylsiloxanes of the general formula

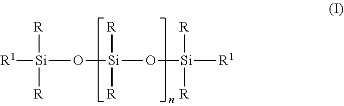

where
R is a methyl radical,
R¹ is a methyl radical or an OR² radical,
R² may be the same or different and is a hydrogen atom or a monovalent hydrocarbyl radical having 1 to 4 carbon atoms,
n is an integer,
(B) fillers
(C) organopolysiloxane resins formed from units of the formula

R³ₐ(R⁴O)_{b}SiO_{(4-a-b)/2} (II)
where
R³ may be the same or different and is a hydrogen atom or a monovalent,
SiC-bonded hydrocarbyl radical,
R⁴ may be the same or different and is a hydrogen atom or a monovalent hydrocarbyl radical,
a is 0, 1, 2 or 3 and
b is 0, 1, 2 or 3,
with the proviso that the sum of a+b≤3 and, in less than 50% of all units of the formula (II) in the organopolysiloxane resin, the sum of a+b is 2,
(D) optionally polyorganosiloxanes of the general formula

R⁵O—SiR₂O(SiR₂O)ₘSiR₂—OR⁵ (III)
where
R is as defined above,
R⁵ is a monovalent hydrocarbyl radical having 6 to 30 carbon atoms,
m is an integer,

(E) optionally nonionic emulsifiers,

(F) mono-, di- or trialkoxyalkyl ethers of the following formula

R⁶(OR⁷)ₚO—R⁸ (IV)
where
R⁶ may be the same or different and is a hydrogen atom or a monovalent, optionally substituted hydrocarbyl radical having 1 to 6 carbon atoms,
R⁷ may be the same or different and is a divalent, optionally substituted hydrocarbyl radical having 1 to 6 carbon atoms
R⁸ is a monovalent, optionally substituted hydrocarbyl radical having 1 to 8 carbon atoms,
pis 1, 2 or 3,

(G) nonaqueous solvents other than component (F),

(H) optionally an alkaline or acidic catalyst or reaction product thereof with components (A) to (F),

with the proviso that the involvement of 2,2,4-Trimethyl-1,3-diisobutyryloxypentan is ruled out.

The R² radical is preferably the hydrogen atom, the methyl radical or the ethyl radical.

The R³ radical is preferably a hydrocarbyl radical having 1 to 30 carbon atoms, more preferably a hydrocarbyl radical having 1 to 6 carbon atoms, especially the methyl radical.

Examples of the R³ radical are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, hexadecyl radicals, such as the n-hexadecyl radical, octadecyl radicals, again n-octadecyl radical; alkenyl radicals, such as the vinyl radical and the allyl radical; cycloalkyl radicals, such as cyclopentyl, cyclohexyl, cycloheptyl radicals and methylcyclohexyl radicals, aromatic groups bonded to the silicon atoms via aliphatic groups, such as the benzyl radical, phenylethyl radical or the 2-phenylpropyl radical.

Examples of R⁴ radicals are the hydrogen atom or the radicals specified for the R³ radical.

The R⁴ radical is preferably the hydrogen atom or a hydrocarbyl radical having 1 to 4 carbon atoms, especially the hydrogen atom, the methyl radical or the ethyl radical.

The R⁵ radical is preferably an aliphatic hydrocarbyl radical having 6 to 30 carbon atoms, for example alkyl radicals, such as the n-hexyl, 2-ethylhexyl, n-dodecyl, isotridecyl and 2-octyldodecyl radical, or cycloalkyl radicals, such as the methylcyclohexyl radical, especially the 2-octyldodecyl radical.

Examples of the R⁶ radical are the hydrogen atom or alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical. Preferred examples of the R⁶ radical are the hydrogen atom, the methyl radical or the ethyl radical, particular preference being given to the hydrogen atom.

Examples of the R⁷ radical are optionally branched alkyl radicals, such as the 1,2-ethylene radical, 1,2-propylene radical, 1,3-propylene radical, 1,2-butylene radical, 1,3-butylene radical, 1,4-butylene radical or the 1,6-hexylene radical, especially the 1,2-ethylene radical or the 1,2-propylene radical.

Examples of the R⁸ radical are alkyl radicals, such as the methyl, ethyl, n-propyl, isopropyl, n-butyl, isobutyl, tert-butyl, n-pentyl, isopentyl, neopentyl, tert-pentyl radical, hexyl radicals, such as the n-hexyl radical, phenyl radical, benzyl radical, especially the methyl radical or the n-butyl radical.

The value for a is preferably 3 or 0.

m is preferably an integer, where m is chosen such that the polyorganosiloxanes of the formula (III) preferably have a viscosity of 10 to 10 000 mPa·s, preferably of 20 to 1000 mPa·s, especially of 40 to 200 mPa·s, measured in each case at 25° C. and a shear rate of 1/s.

Index m thus preferably has a value of 5 to 500, preferably of 15 to 200, especially of 30 to 100.

The polysiloxanes (A) have a viscosity of preferably 10 to 1 000 000 mPa·s, more preferably of 50 to 100 000 mPa·s, especially of 100 to 10 000 mPa·s, measured in each case at 25° C. and a shear rate of 1/s.

Index n in the polysiloxanes (A) of the formula (I) thus preferably has a value of 5 to 2500, preferably of 20 to 1000, especially of 70 to 500.

The polysiloxanes (A) are commercial products or can be prepared by any methods known to date in organosilicon chemistry, for example by cohydrolysis of the corresponding silanes.

Polysiloxanes (A) may be branched, for example, by the incorporation of RSiO_{3/2} or SiO_{4/2} units up to a maximum of 5% of all units. These branched or incipiently crosslinked polysiloxanes then have viscoelastic properties.

The polysiloxanes (A) are preferably linear.

Preferably, in the defoamer compositions of the invention, the involvement of amino-functional polysiloxanes, polyethersiloxanes and polysiloxanes having long-chain SiC-bonded C₈₋₃₀-alkyl radicals is ruled out.

The defoamer compositions of the invention contain the polysiloxanes (A) preferably in amounts of 3 to 70 percent by weight, preferably 4 to 60 percent by weight, especially 5 to 50 percent by weight, based in each case on the total weight of the defoamer compositions.

Component (B) preferably comprises pulverulent, preferably hydrophobic, fillers.

Component (B) preferably has a BET surface area of 20 to 1000 m²/g, a particle size of less than 10 μm and an agglomerate size of less than 100 μm.

Examples of component (B) are silicon dioxide (silicas), titanium dioxide, aluminum oxide, metal soaps, ground quartz, PTFE powder, fatty acid amide, e.g. ethylenebisstearamide, finely divided hydrophobic polyurethanes.

Components (B) used are preferably silicon dioxide (silicas), titanium dioxide or aluminum oxide, especially having a BET surface area of 20 to 1000 m²/g, a particle size of less than 10 μm and an agglomerate size of less than 100 μm.

Preferred components (B) are silicas, more preferably those having a BET surface area of 50 to 800 m²/g, especially those having a BET surface area of 80 to 500 m²/g. These silicas may be fumed or precipitated silicas. Usable components (B) are either pretreated silicas, i.e. commercial hydrophobic silicas, or hydrophilic silicas. The degree of hydrophobization is characterized by the methanol value. This is ascertained in accordance with DE 2107082 A1, by adding 0.2 g of the silica to 50 ml of water. Methanol is added while stirring until the silica is completely wetted and is suspended in the liquid. The methanol value is the percentage of methanol in the liquid mixture that just wets the silica. Pretreated hydrophobic silicas used are preferably silicas having a methanol value of more than 30, especially of more than 50. Examples of commercial hydrophobic silicas that can be used in accordance with the invention are HDK® H2000, a fumed silica treated with hexamethyldisilazanes and having a BET surface area of 140 m²/g (commercially available from Wacker-Chemie AG, Munich, Germany) and a precipitated silica treated with polydimethylsiloxane and having a BET surface area of 90 m²/g (commercially available under the “Sipernat D10” name from Evonik Resource Efficiency GmbH, Hanau, Germany).

If hydrophobic silicas are to be used as component (B), it is also possible to hydrophobize hydrophilic silicas in situ if this is advantageous for the desired efficacy of the defoamer formulation. A number of methods of hydrophobization of silicas are known. In situ hydrophobization of the hydrophilic silica can be effected, for example, by heating the silica dispersed in component (A) to temperatures of 100 to 200° C. for several hours. The reaction here can be assisted by the addition of catalysts, such as KOH, and of hydrophobizing agents, such as short-chain OH-terminated polydimethylsiloxanes, silanes or silazanes. This treatment is also possible when commercial hydrophobic silicas are used and can contribute to an improvement in efficacy.

A further option is the use of a combination of silicas that have been hydrophobized in situ with commercial hydrophobic silicas. In this case, preference is given to using 0.2 to 5 parts pretreated hydrophobized silica to 1 part silica hydrophobized in situ.

Fillers (B) are used in the defoamer compositions of the invention preferably in amounts of 0.5 to 15 percent by weight, preferably of 1.0 to 10 percent by weight, especially of 1.5 to 7.5 percent by weight, based in each case on the total weight of the defoamer compositions.

Component (C) more preferably comprises organopolysiloxane resins consisting essentially of R³₃SiO_{1/2}(M) and SiO_{4/2}(Q) units, where R³ is as defined above. Organopolysiloxane resins consisting essentially of R³₃SiO_{1/2}(M) and SiO_{4/2}(Q) units are also referred to as MQ resins. The molar ratio of M to Q units is preferably in the range from 0.5 to 2.0, more preferably in the range from 0.6 to 1.0. The organopolysiloxane resins (C) may also contain up to 10% by weight of free, Si-bonded hydroxy or C₁₋₄-alkoxy groups. R³ is preferably a methyl radical.

The organopolysiloxane resins (C) preferably have a viscosity at 25° C. of greater than 1000 mPa·s or are solids. The weight-average molecular weight Mw, determined by gel permeation chromatography (based on a polystyrene standard), of these resins is preferably 200 to 200 000 g/mol, especially 1000 to 20 000 g/mol.

The organopolysiloxane resins (C) used in accordance with the invention are preferably soluble in benzene to an extent of at least 100 g/I at a temperature of 25° C. and a pressure of 101.325 kPa.

Organopolysiloxane resins (C) are used in the defoamer compositions of the invention in amounts of preferably at least 0.1 percent by weight and preferably not more than 15 percent by weight, more preferably not more than 10 percent by weight, especially not more than 7.5 percent by weight, based in each case on the total weight of the defoamer compositions.

The organopolysiloxanes (D) optionally used have a viscosity of preferably 10 to 10 000 mm²/s at 25° C.

Examples of the organopolysiloxanes (D) optionally used are those organopolysiloxanes of the general formula (III) in which R⁵ is a linear and/or branched hydrocarbyl radical having at least 6 carbon atoms. Such products are obtainable, for example, by alkali-catalyzed condensation of silanol-terminated polydimethylsiloxanes of viscosity 10 to 10 000 mPa·s at 25° C. and aliphatic alcohols having more than 6 carbon atoms, such as n-hexanol, 2-ethylhexanol, n-dodecanol, isotridecanol, 2-octyldodecanol or methylcyclohexanol.

These polydimethylsiloxanes may be branched, for example, by the incorporation of RSiO_{3/2} or SiO_{4/2} units up to a maximum of 5% of all units. These branched or incipiently crosslinked siloxanes then have viscoelastic properties.

If the compositions of the invention do contain component (D), the amounts are preferably up to 15 percent by weight, preferably up to 5 percent by weight, especially up to 2 percent by weight, based in each case on the total weight of the defoamer compositions.

Examples of nonionic emulsifiers (E) optionally used are:
1. Alkyl polyglycol ethers, preferably those having 4 to 30 EO units and alkyl radicals of 10 to 20 carbon atoms.
2. Carboxylic acid polyglycol esters, especially fatty acid polyglycol esters, preferably those having greater than 6 EO units and carboxylic acid residues of 8 to 20 carbon atoms.
3. Ethoxylated or non-ethoxylated sorbitan fatty acid esters, preferably ethoxylated sorbitan fatty acid esters having greater than 6 EO units.
4. Ethoxylated castor oil or hydrogenated variants.
5. Polyglycerolcarboxylic esters.
6. Alkyl polyglycosides of the general formula R*—O—Z_{O} in which R* is a linear or branched, saturated or unsaturated alkyl radical having an average of 8-24 carbon atoms and Z_{O} is an oligoglycoside residue having an average of o=1-10 hexose or pentose units or mixtures thereof.
7. Alkylaryl polyglycol ethers, preferably those having 5 to 30 EO units and 10 to 20 carbon atoms in the alkyl and aryl radicals.
8. Ethylene oxide/propylene oxide (EO/PO) block copolymers, preferably those having 8 to 30 EO or PO units.

Preferred nonionic emulsifiers are
2. Carboxylic acid polyglycol esters, especially fatty acid polyglycol esters, preferably those having greaten than 6 EO units and carboxylic acid residues of 8 to 20 carbon atoms, for example PEG-20 stearate, PEG-20 laurate, PEG-7 Olivate, PEG-8 Oleate, PEG-8 Laurate, HLB PEG-6 Stearate, PEG-20 Stearate or PEG-100 Stearate (by INCI name).
3. Ethoxylated or non-ethoxylated sorbitan fatty acid esters, for example Laurate, Polysorbate 20, Polysorbate 60, Polysorbate 80, Polysorbate 85 (by INCI name), PEG-20 Sorbitan Cocoate, PEG-40 Sorbitan Diisostearate, PEG-20 Sorbitan Isostearate, PEG-40 Sorbitan Lanolate, PEG-75 Sorbitan Lanolate, PEG-10 Sorbitan Laurate, PEG-40 Sorbitan Laurate, PEG-44 Sorbitan Laurate, PEG-75 Sorbitan Laurate, PEG-80 Sorbitan Laurate, PEG-3 Sorbitan Oleate, PEG-6 Sorbitan Oleate, PEG-80 Sorbitan Palmitate, PEG-40 Sorbitan Perisostearate, PEG-40 Sorbitan Peroleate, PEG-3 Sorbitan Stearate, PEG-6 Sorbitan Stearate, PEG-40 Sorbitan Stearate, PEG-60 Sorbitan Stearate, PEG-30 Sorbitan Tetraoleate, PEG-40 Sorbitan Tetraoleate, PEG-60 Sorbitan Tetraoleate, PEG-60 Sorbitan Tetrastearate, PEG-160 Sorbitan Triisostearate; PEG-20 Sorbitan Triisostearate, Sorbeth-40 Hexaoleate, Sorbeth-50 Hexaoleate, Sorbeth-30 Tetraoleate Laurate, Sorbeth-60 Tetrastearate.
4. Ethoxylated castor oil or hydrogenated variants, for example (name in INCI nomenclature) PEG 200 Castor Oil or PEG-60 hydrogenated Castor Oil.
5. Polyglycerolcarboxylic esters, for example Polyglycerin-10 oleate, Polyglycerin-10 laurate or Polyglycerin-10 stearate.
6. Alkyl polyglycosides of the general formula R*—O—Z_{O} in which R* is a linear or branched, saturated or unsaturated alkyl radical having an average of 8-24 carbon atoms and Z_{O} is an oligoglycoside residue having an average of o=1-10 hexose or pentose units or mixtures thereof, for example Glucopon 215, Glucopon 225, Glucopon 600 (trade names).

If the compositions of the invention do contain nonionic emulsifiers (E), the amounts are preferably up to 20% by weight, more preferably up to 15% by weight, especially up to 10% by weight, based in each case on the total weight of the defoamer compositions.

Mono, di- or trialkoxyalkyl ethers (F) are glycol ethers, for example ethylene glycol ethers, propylene glycol ethers or butylene glycol ethers.

Examples of ethylene glycol ethers are
ethylene glycol monomethyl ether (methylglycol, 2-methoxyethanol, CH₃—O—CH₂CH₂—OH),
ethylene glycol monoethyl ether (ethylglycol, 2-ethoxyethanol, CH₃CH₂—O—CH₂CH₂—OH)
ethylene glycol monopropyl ether (2-propoxyethanol, CH₃CH₂CH₂—O—CH₂CH₂—OH)
ethylene glycol monoisopropyl ether (2-isopropoxyethanol, (CH₃)₂CH—O—CH₂CH₂—OH)
ethylene glycol mono-n-butyl ether (2-butoxyethanol, CH₃CH₂CH₂CH₂—O—CH₂CH₂—OH
ethylene glycol monophenyl ether (2-phenoxyethanol, C₆H₅—O—CH₂CH₂—OH)
ethylene glycol monohexyl ether (2-hexyloxyethanol, C₆H₁₁—O—CH₂CH₂—OH)
ethylene glycol monobenzyl ether (2-benzyloxyethanol, C₆H₅CH₂—O—CH₂CH₂—OH)
diethylene glycol monomethyl ether [2-(2-methoxyethoxy)ethanol, methylcarbitol, CH₃—O—CH₂CH₂—O—CH₂CH₂—OH]
diethylene glycol monoethyl ether [2-(2-ethoxyethoxy)ethanol, carbitol cellosolve, CH₃CH₂—O—CH₂CH₂—O—CH₂CH₂—OH]
diethylene glycol mono-n-butyl ether [2-(2-butoxyethoxy)ethanol, CH₃CH₂CH₂CH₂—O—CH₂CH₂—O—CH₂CH₂—OH]
triethylene glycol mono-n-butyl ether (butyltriglycol)
diethylene glycol diethyl ether (diethylcarbitol)
dibutylene glycol dibutyl ether (dibutylcarbitol)

Examples of propylene glycol ethers are
propylene glycol monomethyl ether (1-methoxy-2-propanol)
propylene glycol monoethyl ether (ethoxypropanol)
propylene glycol mono-n-butyl ether (1-butoxy-2-propanol)
propylene glycol monohexyl ether (1-hexoxy-2-propanol)
dipropylene glycol monoethyl ether
dipropylene glycol mono-n-butyl ether
dipropylene glycol monohexyl ether
tripropylene glycol monomethyl ether
tripropylene glycol mono-n-butyl ether
tripropylene glycol dimethyl ether

Examples of butylene glycol ethers are
butylene glycol monomethyl ether (1-methoxy-2-propanol)
butylene glycol monobutyl ether (ethoxypropanol)

Mono, di- or trialkoxyalkyl ethers (F) can be purchased commercially, for example, under the Dowanol® (from Dow), Arcosolv® (from LyondellBasell), Ektasolve® or Eastman® (both from Eastman) brand names.

Preferred examples of mono, di- or trialkoxyalkyl ethers (F) are ethylene glycol monomethyl ether,
ethylene glycol monoethyl ether,
ethylene glycol mono-n-butyl ether,
diethylene glycol monomethyl ether,
diethylene glycol mono-n-butyl ether,
propylene glycol monomethyl ether,
propylene glycol monoethyl ether,
propylene glycol mono-n-butyl ether or
dipropylene glycol mono-n-butyl ether.

Especially preferred examples of mono, di- or trialkoxyalkyl ethers (F) are ethylene glycol mono-n-butyl ether, diethylene glycol mono-n-butyl ether,
propylene glycol mono-n-butyl ether or
dipropylene glycol mono-n-butyl ether.

The compositions of the invention contain mono, di- or trialkoxyalkyl ethers (F) preferably in amounts of 5 to 50 percent by weight, more preferably 7.5 to 40 percent by weight, especially 10 to 30 percent by weight, based in each case on the total weight of the defoamer compositions.

Component (G) used particularly preferably comprises organic solvents having a boiling point greater than 100° C. at the pressure of the surrounding atmosphere, i.e. at 900 to 1100 hPa, especially compounds that cannot be distilled without decomposition, especially those selected from hydrocarbons, native oils, polyisobutylenes, fatty acid esters, fatty alcohols and waxes.

Examples of hydrocarbons are isoparaffins (obtainable, for example, under the Isopar® E, Isopar® G, Isopar® H, Isopar® J, Isopar® L, Isopar® M, Isopar® N, Isopar® P, Isopar® V trade name from ExxonMobil), dearomatized hydrocarbons (obtainable, for example, under the Exxsol® D40, Exxsol® 60, Exxsol® D95, Exxsol® D100, Exxsol® D130 trade name from ExxonMobil), aromatic solvents (obtainable, for example, under the Solvesso® trade name from ExxonMobil) or mineral oils or white oils.

Examples of isobutylenes are products commercially available under the Indopol® (from Ineos) or Oppanol® (from BASF) brand name.

Examples of native oils are coconut oil, linseed oil, MCT oil, palm oil, palm kernel oil, rapeseed oil, soya oil, castor oil or sunflower oil. Examples of fatty acid esters are fatty acid methyl esters, fatty acid ethyl esters, fatty acid isopropyl esters, fatty acid amyl esters, fatty acid octyl esters, fatty acid dodecyl esters. Particular mention should be made here of the following examples: methyl laurate, isopropyl laurate, isoamyl laurate, lauryl laurate, ethylhexyl oleate, ethylhexyl cocoate, ethylhexyl stearate, ethylhexyl palmitate, n-butyl stearate, isopropyl myristate, isopropyl oleate and isopropyl palmitate.

Examples of fatty alcohols are hexyl/octyl alcohol, octyl alcohol, decyl alcohol, lauryl alcohol, myristyl alcohol, cetyl alcohol, stearyl alcohol, octyl/decyl alcohol, lauryl/myristyl alcohol, lauryl/cetyl alcohol and lauryl/stearyl alcohol.

Examples of waxes are natural waxes, such as animal waxes (wool wax or beeswax), plant waxes (sugarcane wax, carnauba wax, candelilla wax, cork wax, cotton wax), mineral/fossil waxes (mineral oil wax, peat wax, montan wax, Vaseline), semisynthetic waxes (wax alcohols, such as partly hydrolyzed ester waxes, emulsifier-containing ester waxes, amide waxes based on fatty acids, for example distearylethylenediamide or ethylenedistearamide) or synthetic waxes (polyethylene waxes, polyolefin waxes).

Component (G) may be used in the defoamer compositions preferably in amounts of 10 to 80 percent by weight, more preferably 15 to 70 percent by weight, especially 20 to 60 percent by weight, based in each case on the total weight of the defoamer compositions.

Examples of alkaline catalysts (H) are alkali metal and alkaline earth metal hydroxides, such as NaOH, KOH, CsOH, LiOH and Ca(OH)₂. Examples of acidic catalysts (H) are hydrochloric acid, sulfuric acid and phosphorus nitride chlorides. The reaction products of (H) with components (A) to (D) are, for example, the product of the silica which is preferred as a filler (B) with alkali metal hydroxide, for example potassium silicate or sodium silicate.

The metered addition of the catalyst can be effected in typical organic solvents such as alcohol (for example methanol, ethanol, isopropanol) or esters (for example ethyl acetate).

If the compositions of the invention do contain component (H), the amounts are preferably up to 1.0 percent by weight, preferably up to 0.5 percent by weight, especially up to 0.1 percent by weight, based in each case on the total weight of the defoamer compositions.

Components (A) to (G) used in the defoamer compositions of the invention may each be one type of such a component or else a mixture of at least two types of a respective component.

In the defoamer compositions of the invention, water is present preferably in amounts of less than 5% by weight, preferably less than 1% by weight, based in each case on the total weight of the defoamer compositions. The defoamer compositions of the invention preferably do not contain any added water.

In addition, the defoamer compositions of the invention may include additives (I). These are all known additives selected from organic thickening polymers, preservatives, dyes and fragrances.

The compositions of the invention are preferably viscous, clear to opaque, colorless to brownish liquids.

The compositions of the invention have a viscosity of preferably 1 to 20 000 mPa·s, more preferably 5 to 5000 mPa·s, especially 10 to 2000 mPa·s, measured in each case at 25° C. and a shear rate of 1/s.

The compositions of the invention may be solutions or dispersions.

The compositions of the invention can be produced by known methods, for example by mixing of all components, for example by simple stirring with static mixers or else using high shear forces in colloid mills, dissolvers and rotor-stator homogenizers.

The defoamer compositions of the invention may be present in liquid wetting agents, washing compositions and cleaning compositions.

In the method of the invention for defoaming aqueous media, preferably aqueous surfactant formulations, the composition of the invention is preferably mixed with the aqueous media.

The composition of the invention can be added to the foaming media directly, dissolved in suitable solvents, such as toluene, xylene, methyl ethyl ketone or t-butanol, or in the form of a powder or emulsion. The amount needed to achieve the desired defoamer effect is guided, for example, by the nature of the medium, the temperature and the turbulence that occurs.

The compositions of the invention are preferably mixed directly with concentrated liquid surfactant formulations, for example liquid washing compositions.

The compositions of the invention are preferably added to the ready-to-use foaming medium in amounts of 0.1 ppm by weight to 1% by weight, preferably in amounts of 1 to 100 ppm by weight. The compositions of the invention may be present in concentrated surfactant formulations such as liquid washing compositions in amounts of preferably 0.1% to 20% by weight, more preferably 0.5% to 5% by weight.

The method of the invention is conducted at temperatures of preferably −10 to +150° C. more preferably 5 to 100° C., and the pressure of the surrounding atmosphere, i.e. about 900 to 1100 hPa. The method of the invention can also be conducted at higher or lower pressures, for instance at 3000 to 4000 hPa or 1 to 10 hPa.

The defoamer compositions can be used in accordance with the invention wherever disruptive foam is to be suppressed. This is the case, for example, in nonaqueous systems, as in tar distillation or mineral oil processing. In particular, the use of the defoamer composition is suitable for control of foam in aqueous surfactant systems, for use in washing and cleaning compositions, for control of foam in wastewater facilities, in textile dyeing processes, in natural gas scrubbing, in polymer dispersions, and for defoaming of aqueous media obtained in chemical pulp production.

In particular, the defoamer composition is used in accordance with the invention in liquid washing compositions, where the defoamer compositions are notable for excellent compatibility and efficacy.

The use of the defoamer compositions has the advantage that the compositions are easy to handle as defoamers, are miscible with concentrated surfactant formulations, and are notable for high, long-lasting efficacy in a wide variety of different media with small added amounts. This is exceptionally advantageous both in economic and environmental terms.

The method of the invention has the advantage that it is easy to perform and very economically viable.

In the examples that follow, all parts and percentage figures, unless stated otherwise, relate to weight.

Unless stated otherwise, the examples that follow are conducted at a pressure of the surrounding atmosphere, i.e. at about 1000 hPa, and at room temperature, i.e. about 20° C. or a temperature which is established when the reactants are combined at room temperature without additional heating or cooling.

Dynamic viscosities were measured using an “MCR 302” rheometer from Anton Paar to DIN EN ISO 3219: 1994 and DIN 53019, using a cone-plate system (CP50-2 cone) with an opening angle of 2°. The instrument was calibrated with 10000 standard oil from the German National Metrology Institute. The measurement temperature is 25.00° C.+/−0.05° C., the measurement time 3 min. The viscosity figure (reported in mPa·s) is the arithmetic average of three independently conducted individual measurements. The measurement uncertainty associated with dynamic viscosity is 1.5%. The shear rate gradient was chosen depending on the viscosity and is quoted separately for each viscosity figure.

Kinematic viscosities are determined by means of a ViscoSystem® AVS 350 viscosity measurement system from Schott using Ubbelohde viscometer tubes with a constant (for example from Windaus or from VWR) to DIN 51562 Part 1 or ISO/DIS 3105 (including calibration thereof). The measurements are effected at a temperature of 25.0° C. (+−0.1° C.). The viscosity figure (reported in mm2/s) is the arithmetic average of three independently conducted individual measurements: the measurement uncertainty associated with kinematic viscosity is 1.05%. Depending on the measurement range, different viscometer tubes with corresponding guide constants are used:

| | | |
|---|---|---|
| Measurement | Capillary | Guide |
| range | No. | constant |

| | | | |
|---|---|---|---|
| 0.5-3 | mm²/s | 0c | 0.003K |
| 0.8-5 | mm²/s | 0a | 0.005K |
| 1.2-10 | mm²/s | I | 0.01K |
| 3-30 | mm²/s | Ic | 0.03K |
| 10-100 | mm²/s | II | 0.10K |
| 30-300 | mm²/s | IIc | 0.30K |
| 100-1000 | mm²/s | III | 1K |
| 300-3000 | mm²/s | IIIc | 3K |
| 1000-10000 | mm²/s | IV | 10K |

Statement of measurement range, the corresponding capillary No. and the constant according to VWR laboratory catalogue, 2011-2013, p. 645.8.

### EXAMPLE 1: PRODUCTION OF ANTIFOAMS

### Antifoam A:

A mixture of 87.3 parts by weight of a trimethylsiloxy-terminated polydimethylsiloxane of viscosity 8000 mm²·s (25.0° C.; capillary No. IV), 6 parts by weight of a hydrophilic fumed silica having a BET surface area of 300 m²/g, 3 parts of a 2-octyldodecyloxy-terminated polydimethylsiloxane of viscosity about 180 mm²·s⁻¹ (25.0° C.; capillary No. IIc), 3 parts of a room-temperature-solid silicone resin consisting of the following units (by ²⁹Si NMR and IR analysis): 40 mol % of CH₃SiO_{1/2}—, 50 mol % of SiO_{4/2}—, 8 mol % of C₂H₅OSiO_{3/2}— and 2 mol % of HOSiO_{3/2}—; this resin had a weight-average molar mass of 7900 g/mol (based on polystyrene standard), and 0.7 parts of a 20% by weight methanolic KOH were mixed with a dissolver and heated to 150° C. for 4 hours. An antifoam A with a viscosity of 27 600 mPa·s (measured at 25° C. and a shear rate of 1 1/s) was obtained.

### Antifoam B:

A mixture of 85.6 parts by weight of a trimethylsiloxy-terminated polydimethylsiloxane of viscosity 8000 mm²·s (25.0° C.; capillary No. IV), 5 parts of a trimethylsiloxy-terminated polydimethylsiloxane of viscosity about 100 mm²·s⁻¹ (25.0° C.; capillary No. IIc), 6 parts by weight of a fumed silica having a BET surface area of 300 m²/g, 3 parts of a room-temperature-solid silicone resin consisting of the following units (by ²⁹Si NMR and IR analysis): 40 mol % of CH₃SiO_{1/2}—, 50 mol % of SiO_{4/2}—, 8 mol % of C₂H₅OSiO_{3/2}— and 2 mol % of HOSiO_{3/2}—; this resin had a weight-average molar mass of 7900 g/mol (based on polystyrene standard), and 0.4 parts of a 20% by weight methanolic KOH were mixed with a dissolver and heated to 150° C. for 4 hours. An antifoam A with a viscosity of 28 800 mPa·s (measured at 25° C. and a shear rate of 1 1/s) was obtained.

### EXAMPLE 2: PRODUCTION OF THE DEFOAMER FORMULATIONS

### Defoamer Formulation F1:

An initial charge is formed by 43.5 parts by weight of a hydrocarbon mixture having a boiling range of 235-270° C., 16.5 parts by weight of dipropylene glycol monobutyl ether (commercially available under the Dowanol® DPnB name) and 5.0 parts by weight of the room-temperature-solid silicone resin from example 1. 35.0 parts by weight of antifoam A are added and stirred in well with a paddle stirrer at 1200 rpm for 1 min.

Defoamer formulation F1 is the result, being a virtually clear, homogeneous formulation having a viscosity of 230 mPa·s (measured at 25° C. and a shear rate of 1 1/s). This is notable for very good storage stability.

### Defoamer Formulation F2:

An initial charge is formed by 5.0 parts by weight of a hydrocarbon mixture having a boiling range of 235-270° C., 27.5 parts by weight of dipropylene glycol monobutyl ether (commercially available under the Dowanol® DPnB name), 27.5 parts by weight of isopropyl laurate (commercially available under the IPL name from ICOF Europe) and 5.0 parts by weight of the room-temperature-solid silicone resin from example 1. 35.0 parts by weight of antifoam A is added and stirred in well with a paddle stirrer at 1200 rpm for 1 min.

Defoamer formulation F2 is the result, being a virtually clear, homogeneous formulation having a viscosity of 250 mPa·s (measured at 25° C. and a shear rate of 1 1/s). This is notable for very good storage stability.

### Defoamer Formulation F3:

An initial charge is formed by 22.5 parts by weight of dipropylene glycol monobutyl ether (commercially available under the Dowanol® DPnB name), 22.5 parts by weight of isopropyl laurate (commercially available under the IPL name from ICOF Europe), 15.0 parts by weight of a trimethylsiloxy-terminated polydimethylsiloxane of viscosity 100 mm²·s (25.0° C.; capillary No. IIc) and 5.0 parts by weight of the room-temperature-solid silicone resin from example 1. 35.0 parts by weight of antifoam B are added and stirred in well with a paddle stirrer at 1200 rpm for 1 min.

Defoamer formulation F3 is the result, being a virtually clear, homogeneous formulation having a viscosity of 370 mPa·s (measured at 25° C. and a shear rate of 1 1/s). This is notable for very good storage stability.

### Defoamer Formulation F4:

An initial charge is formed by 31.5 parts by weight of a hydrocarbon mixture having a boiling range of 235-270° C., 13.5 parts by weight of dipropylene glycol monobutyl ether (commercially available under the Dowanol® DPnB name), 15.0 parts by weight of a trimethylsiloxy-terminated polydimethylsiloxane of viscosity 100 mm²·s (25.0° C.; capillary No. IIc) and 5.0 parts by weight of the room-temperature-solid silicone resin from example 1. 35.0 parts by weight of antifoam A are added and stirred in efficiently with a paddle stirrer at 1200 rpm for 1 min.

Defoamer formulation F4 is the result, being a virtually clear, homogeneous formulation having a viscosity of 340 mPa·s (measured at 25° C. and a shear rate of 1 1/s). This is notable for very good storage stability.

### Defoamer Formulation F5:

An initial charge is formed by 53.5 parts by weight of a hydrocarbon mixture having a boiling range of 235-270° C. and 23.0 parts by weight of diethylene glycol monobutyl ether (commercially available under the Dowanol® DGNB name). 3.0 parts by weight of a hydrophobic fumed silica having a BET surface area of 180 m²/g (available under the HDK® T30 name, Wacker Chemie AG, Munich) and 3.0 parts by weight of a hydrophobic, precipitated silica having a BET surface area of 100 m²/g (available under the Aerosil® R 202 name, Evonik) are added and incorporated well with a paddle stirrer at 1200 rpm for 1 min. 10.0 percent by weight of polyoxyethylenesorbitan hexaoleate and 7.5 parts by weight of the antifoam A are added and likewise stirred in well with a paddle stirrer at 1200 rpm for 1 min.

Defoamer formulation F5 is the result, being a slightly turbid, homogeneous formulation having a viscosity of 580 mPa·s (measured at 25° C. and a shear rate of 1 1/s). This is notable for very good storage stability.

### (Comparative) Defoamer Formulation VF6:

The production of defoamer formulation F1 is repeated, except replacing a majority of the hydrocarbon mixture having a boiling range of 235-270° C. (38.5 percent by weight) and the diethylene glycol monopropyl ether with 2,2,4-trimethyl-1,3-diisobutyryloxypentane (55.0 parts by weight) (as described in U.S. Pat. No. 4,477,371 A).

Defoamer formulation VF6 is the result, being a cloudy, homogeneous formulation having a viscosity of 340 mPa·s (measured at 25° C. and a shear rate of 1 1/s).

### (Comparative) Defoamer Formulation VF7:

The production of defoamer formulation F5 is repeated, except replacing the hydrocarbon mixture having a boiling range of 235-270° C. and the diethylene glycol monobutyl ether with 2,2,4-trimethyl-1,3-diisobutyryloxypentane (55.0 parts by weight) (as described in U.S. Pat. No. 4,477,371 A).

Defoamer formulation VF7 is the result, being a cloudy, homogeneous formulation having a viscosity of 90 mPa·s (measured at 25° C. and a shear rate of 1 1/s).

### (Comparative) Defoamer Formulation VF8:

The production of defoamer formulation F1 is repeated, except using, rather than the antifoam A, an aminoethylaminopropyl-functionalized polydimethylsiloxane of viscosity 893 mPa·s (measured at 25° C. and a shear rate of 1 1/s) and amine value 0.29 mequ·/g. The result is a (comparative) defoamer formulation VF8, as a clear homogeneous formulation.

### (Comparative) Defoamer Formulation VF9:

The production of defoamer formulation F1 is repeated, except using, rather than the antifoam A, an n-dodecyl-functionalized polydimethylsiloxane of viscosity 1130 mPa·s (measured at 25° C. and a shear rate of 1 1/s). It is not possible to produce a stable formulation.

### (Comparative) Defoamer Formulation VF10:

The production of defoamer formulation F1 is repeated, except using, rather than the antifoam A, a polyether-functionalized polydimethylsiloxane having polyethylene oxide-polypropylene oxide side chains of viscosity 630 mPa·s (measured at 25° C. and a shear rate of 1 1/s). The result is a (comparative) defoamer formulation VF10, as a cloudy homogeneous formulation.

### EXAMPLE 3: COMPATIBILITY OF THE DEFOAMER FORMULATIONS IN A COMMERCIAL LIQUID WASHING COMPOSITION

An initial charge is formed by 40 parts by weight of a commercially available liquid washing composition of the Tide brand (Procter & Gamble). 0.12 parts by weight of defoamer formulations F1 to F4 and VF6 are stirred in.

The mixtures are stored at 40° C. for 8 weeks and then assessed visually.

TABLE 1
Visual assessment after 8-week storage test at 40° C.

| Defoamer | |
|---|---|
| formulation | Compatibility |
| F1 | good compatibility |
| F2 | good compatibility |
| F3 | good compatibility |
| F4 | good compatibility |
| VF6 | poor compatibility |

It is found that the use of defoamer formulations containing dipropylene glycol monobutyl ether is notable for better compatibility in a liquid washing composition.

### EXAMPLE 4: DEFOAMER EFFICACY WHEN USED AS DEFOAMER IN AN ANIONIC SURFACTANT FORMULATION

To 200 ml of demineralized water is added 8.00 g of an anionic surfactant having the Mersolat H 95 main (from Lanxess), and the mixture is introduced into a 1 liter measuring cylinder. With the aid of a thermostat, the mixture is adjusted to a temperature of 25° C. After addition of 0.1 ml of a 10% by weight formulation of the respective defoamer formulation F5 or VF7 in ethyl methyl ketone, the surfactant solution is foamed up together with the defoamer formulation with the aid of two stirrers. The collapse of the foam, until no foam can be seen any longer, is recorded. The measure is the area beneath the collapse curve, the smaller it is, the better the defoamer effect. What is reported in each case is the average from three measurements. The results are compiled in table 2.

TABLE 2
Collapse of foam in an anionic surfactant solution

| Defoamer | |
|---|---|
| formulation | Foam value |
| F5 | 1165 |
| VF7 | 1807 |
| VF8 | No measurable |
| | antifoam effect |
| VF10 | No measurable |
| | antifoam effect |

The use of defoamer formulation E5 containing diethylene glycol monobutyl ether in an anionic surfactant solution results in much more effective foam collapse than is the case for the (comparative) defoamer formulation VF7.

When the (comparative) defoamer formulation VF8 containing an aminoethylaminopropyl-functionalized polydimethylsiloxane or the (comparative) defoamer formulation VF10 containing a polyether-functionalized polydimethylsiloxane is used, it is not possible to measure any defoamer effect.

### EXAMPLE 5: TESTS OF DEFOAMER EFFICACY WHEN USED IN A WASHING MACHINE

Production of the washing composition formulation W1 for testing of efficacy: To an initial charge of 130.2 g of demineralized water is added 33.7 g of an alkoxylated fatty alcohol (available under the Lutensol® TO 8 name from BASF SE) with vigorous stirring. 11.5 g of sodium dodecylbenzenesulfonate (available as technical grade material from Aldrich) and 11.5 g of sodium dodecylsulfate (available as 90% material from Aldrich) were added and stirred briefly. 11.2 g of propane-1,2-diol (available from Merck) is mixed in. Finally, 2.0 g of sodium citrate tribasic dihydrate (available from Aldrich) was stirred in until all of it had dissolved.

To 60 parts by weight of washing composition formulation W1 was added 0.15 part by weight of defoamer formulations F1 to F4 or VF6. The washing composition formulation was then introduced into a drum washing machine (model: Miele Novotronik W 1935 without Fuzzy Logic) together with 3500 g of clean cotton laundry. Subsequently, the wash program was started. The program runs at a temperature of 40° C. and a water hardness of 3°GH. The foam height was recorded over a period of 89 minutes. The foam grades ascertained over the total period of time (0% no foam measurable to 100% overfoaming) are used to determine the average foam grade. The lower this is, the more effective the defoamer formulation over the overall period of time. The results are collated in table 3.

TABLE 3
Use of washing composition formulation W1:

| Defoamer | Foam grade in the |
|---|---|
| formulation | washing machine |
| F1 | ++++ |
| F2 | + |
| F3 | +++ |
| F4 | +++ |
| VF6 | ++++ |

+ 0-10% foam
++ 11-20% foam
+++ 21-30% foam
++++ 31-40% foam

The use of defoamer formulations F1 to F4 in the washing machine allows very effective control of foam evolution, predominantly to a much better degree than is possible with the (comparative) defoamer formulation VF6 that does not contain dipropylene glycol monobutyl ether.

### EXAMPLE 6: TESTS OF STORAGE STABILITY ON USE IN A WASHING MACHINE

To 60 parts by weight of washing composition formulation W1 were added 0.15 parts by weight of defoamer formulations F1 to F4. The washing composition formulation was then stored in a drying cabinet at 40° C. for 4, 8, 12 weeks. Subsequently, washing machine tests were conducted as described in example 5. The results are summarized in table 4.

TABLE 4
Storage stability in washing composition formulation W1:

| | |
|---|---|
| Defoamer | Foam grade in the washing machine |

| formulation | 0 weeks | 4 weeks | 8 weeks | 12 weeks |
|---|---|---|---|---|
| F1 | ++++ | ++ | ++ | + |
| F2 | + | ++++ | +++++ | ++ |
| F3 | +++ | +++ | +++ | +++ |
| F4 | +++ | +++++ | ++ | ++++ |

+ 0-10% foam
++ 11-20% foam
+++ 21-30% foam
++++ 31-40% foam
+++++ 41-50% foam

The use of defoamer formulations F1 to F4 allows very effective control of foam evolution in the washing machine even after storage in the washing composition formulation.

1-11. (canceled)

12. A method of defoaming an aqueous media, comprising:
providing defoamer compositions, wherein the defoamer compositions comprise
(A) polydimethylsiloxanes of the general formula (I) 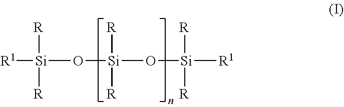
wherein R is a methyl radical,
wherein R¹ is a methyl radical or an OR² radical,
wherein R² may be the same or different and is a hydrogen atom or a monovalent hydrocarbyl radical having 1 to 4 carbon atoms,
wherein n is an integer,
(B) fillers
(C) organopolysiloxane resins formed from units of the formula (II)
R³ₐ(R⁴O)_{b}SiO_{(4-a-b)/2} (II)
wherein R³ may be the same or different and is a hydrogen atom or a monovalent, SiC-bonded hydrocarbyl radical,
wherein R⁴ may be the same or different and is a hydrogen atom or a monovalent hydrocarbyl radical,
wherein a is 0, 1, 2 or 3,
wherein b is 0, 1, 2 or 3, and
wherein the sum of a+b≤3 and, in less than 50% of all units of the formula
(II) in the organopolysiloxane resin, the sum of a+b is 2,
(D) optionally polyorganosiloxanes of the general formula (III)
R⁵O—SiR₂O(SiR₂O)ₘSiR₂—OR⁵ (III)
wherein R is as defined above,
wherein R⁵ is a monovalent, optionally substituted hydrocarbyl radical having 6 to 30 carbon atoms, and
wherein m is an integer,
(E) optionally nonionic emulsifiers,
(F) mono-, di- or trialkoxyalkyl ethers of the following formula (IV)
R⁶(OR⁷)ₚO—R⁸ (IV)
wherein R⁶ may be the same or different and is a hydrogen atom or a monovalent, optionally substituted hydrocarbyl radical having 1 to 6 carbon atoms,
wherein R⁷ may be the same or different and is a divalent, optionally substituted hydrocarbyl radical having 1 to 6 carbon atoms,
wherein R⁸ is a monovalent, optionally substituted hydrocarbyl radical having 1 to 8 carbon atoms,
wherein p is 1, 2 or 3,
(G) nonaqueous solvents other than component (F),
(H) optionally an alkaline or acidic catalyst or reaction product thereof with components (A) to (F), and
wherein the involvement of 2,2,4-trimethyl-1,3-diisobutyryloxypentane and polyethersiloxanes is ruled out.

13. The method of claim 12, wherein the defoamer compositions, the involvement of amino-functional polysiloxanes and polysiloxanes having long-chain SiC-bonded C₈₋₃₀-alkyl radicals is ruled out.

14. The method of claim 12, wherein in the formula (IV),
wherein R⁶ is a hydrogen atom, a methyl radical or an ethyl radical,
wherein R⁷ is a 1,2-ethylene radical or a 1,2-propylene radical, and
wherein R⁸ is a methyl radical or an n-butyl radical.

15. The method of claim 12, wherein the mono, di- or trialkoxyalkyl ether (F) used is
an ethylene glycol monomethyl ether,
an ethylene glycol monoethyl ether,
an ethylene glycol mono-n-butyl ether, diethylene glycol monomethyl ether,
a diethylene glycol mono-n-butyl ether, propylene glycol monomethyl ether, propylene glycol monoethyl ether,
a propylene glycol mono-n-butyl ether or
a dipropylene glycol mono-n-butyl ether.

16. The method of claim 12, wherein fillers (B) used are silicon dioxide (silicas), titanium dioxide or aluminum oxide.

17. The method of claim 12, wherein the organopolysiloxane resins (C) consist essentially of R³₃SiO_{1/2}(M) and SiO_{4/2}(Q) units;
where R³ has the definition given in claim 1; and
wherein the organopolysiloxane resins may contain up to 10% by weight of free Si-bonded hydroxy or C₁₋₄-alkoxy groups.

18. The method of claim 12, wherein nonaqueous solvents (G) used are hydrocarbons, native oils, polyisobutylenes, fatty acid esters, fatty alcohols and waxes.

19. The method of claim 12, wherein the defoamer compositions are mixed with the aqueous media.

20. The method of claim 12, wherein the defoamer compositions are added to the foaming aqueous media in amounts of 0.1 ppm by weight to 1% by weight.

21. The method of claim 12, wherein the defoamer compositions are present in liquid washing compositions.

22. The method of claim 12, wherein the defoamer compositions are present in liquid washing compositions in amounts of 0.1% to 20% by weight, based on the total weight of the liquid washing compositions.

23. The method of claim 12, wherein the defoamer compositions are aqueous surfactant formulations.
